(19) United States
(12) Patent Application Publication
(10) Pub. No.: US 2022/0282350 A1
(43) Pub. Date: Sep. 8, 2022

(54) AUSTENITIC STEEL ALLOY HAVING AN IMPROVED CORROSION RESISTANCE UNDER HIGH-TEMPERATURE LOADING AND METHOD FOR PRODUCING A TUBULAR BODY THEREFROM

(71) Applicant: Mannesmann Stainless Tubes GmbH, Mülheim an der Ruhr (DE)

(72) Inventors: Michael Spiegel, Erkrath (DE); Patrik Schraven, Duisburg (DE)

(21) Appl. No.: 17/637,857

(22) PCT Filed: Aug. 26, 2020
(86) PCT No.: PCT/EP2020/073877

§ 371 Date: Feb. 24, 2022

(30) Foreign Application Priority Data
Aug. 29, 2019 (DE) 102019123174.4

(51) Int. Cl. C21D 9/08; C21D 6/00; C22C 38/50; C22C 38/48; C22C 38/52; C22C 38/44; C22C 38/04; C22C 38/02; C22C 38/00; C22C 38/06; F24S 70/12

(52) U.S. Cl. CPC C21D 9/08; C21D 6/004; C21D 6/005; C21D 6/008; C22C 38/50; C22C 38/48; C22C 38/52; C22C 38/44; C22C 38/04; C22C 38/02; C22C 38/001; C22C 38/06; F24S 70/12; C21D 2211/001

(57) ABSTRACT

An austenitic steel alloy is provided having excellent corrosion resistance under high-temperature loading of more than 600° C. and up to 800° C., with the alloy having the following proposed chemical composition (in wt. %), consisting essentially of: C: 0.01 to 0.10; Si: max. 0.75; Mn: max. 2.00; P: max. 0.03; S: max. 0.03; Cr: 23 to 27; Ni: 17 to 23; Nb: 0.2 to 0.6; N: 0.15 to 0.35; the remainder being Fe and melting-related impurities. In a particular configuration a tubular body is made from this steel alloy, where an absorber pipe of a solar receiver of a solar power installation may be made from the tubular body. Still further, a solar receiver comprising this absorber pipe is provided, as well as a method for producing a tubular body from the steel alloy.

### CROSS REFERENCE TO RELATED APPLICATION

The present application claims the priority benefits of International Patent Application No. PCT/EP2020/073877, filed Aug. 26, 2020, and claims benefit of German patent application no. DE 10 2019 123 174.4, filed on Aug. 29, 2019.

### BACKGROUND AND FIELD OF THE INVENTION

The invention relates to an austenitic steel alloy for operating temperatures of at least 600° C. to 800° C. Furthermore, the invention relates to a tubular body consisting of this steel alloy, an absorber tube of a solar receiver of a solar power plant consisting of this tubular body and a solar receiver comprising such an absorber tube. The invention also relates to a method for producing a tubular body from this steel alloy.

With the development of solar thermal power plants and the decline in fossil-fueled power plants forced by the energy revolution, there is a demand for new markets with in part highly specialized application portfolios and the necessity to provide corresponding materials. One of these scenarios is solar thermal power plants based on molten salt, in which tubes are installed and transport heat in a similar way to steam power plants. The transport takes place via molten salts heated by solar radiation, in particular in the design of solar thermal power plants as so-called tower receivers. In this case, the solar radiation is concentrated on the top of a tower by a field of individually tracked mirrors (heliostats). With this concept, temperatures in excess of 1000° C. can be reached at the top of the tower. Located at the top of the tower is a solar receiver which converts the radiation into heat and outputs it to a heat transfer medium which feeds the heat to a conventional power plant process.

The solar receiver receives the solar radiation with a tube bundle. This tube bundle is occasionally provided with a black coating for better absorption of the radiation. Flowing inside the tube is the molten salt, such as e.g. a nitrate salt mixture, which transfers and stores the heat. In a heat exchanger, the heat from the molten salt is transferred to a steam circuit which then generates electricity via the Carnot process. The temperatures of the molten salt are generally up to about 620° C., in some cases specific parts of the absorber tubes can become even hotter.

Steels for this field of application must withstand high corrosion and thermal stresses. High mechanical stability against time-dependent and temperature-dependent creep damage, as well as thermomechanical fatigue by superimposing a mechanical fatigue load with a cyclic thermal load is also required. This requires a correspondingly high level of microstructural stability. The changes which take place as a function of temperature and time relate substantially to the dislocation arrangement, the grain structure and the precipitations.

In addition to nickel-based austenitic steels which are very cost-intensive owing to the high Ni content, austenitic Cr—Ni steels for this application are also disclosed e.g. in laid-open document WO 2016/116227 A1. The steel composition for absorber tubes of a solar thermal power plant comprises on a weight basis: 0% to 0.025% C; 0.05% to 0.16% N; 2.4% to 2.6% Mo; 0.4% to 0.7% Si; 0.5% to 1.63% Mn; 0% to 0.0375% P; 0% to 0.0024% S; 17.15% to 18.0% Cr; 12.0% to 12.74% Ni; 0.0025% to 0.0045% B and contains, as the remainder, Fe and possibly typical impurities. This steel is designed for a temperature range of up to 580° C. at the absorber tube.

Laid-open document WO 2015/014592 A2 also describes for a temperature range of up to 580° C. at the absorber tube an austenitic steel with the following alloy composition on a weight basis: 0.08% or less C; 0% to 0.18% N; 0% to 3.0% Mo; 0% to 1.0% Si; 0% to 1.0% Mn; 0% to 0.035% P; 0% to 0.015% S; 16.0% to 19.0% Cr; 9.0% to 14.0% Ni; 0.0015% to 0.005% B; 0% to 0.23% Cu; 0% to 0.007% Al; 0% to 0.013% Nb; 0% to 0.12% V; 0% to 0.19 Co; and Ti, wherein at least one of the following conditions is met: Ti/C at least 6; Ti 0.24% - 0.64% and contains, as the remainder, Fe and possibly typical impurities.

The disadvantage of the known steel grades is that they are not designed for operating temperatures of at least 600° C. to about 800° C. at the absorber tube, which would lead to a significantly improved economic efficiency of solar power plants, in particular molten salt-based solar power plants.

Furthermore, parts of a steam turbine operating at temperatures of 650° C. or higher are known from European laid-open document EP 1 502 966 A2 and are produced from an austenitic, heat-resistant steel alloy with the following chemical composition, in each case in wt. %: C: 0.45 or less; Si: 1.0 or less; Mn: 2.0 or less; Cr: 19.0 to 25.0; Ni: 18.0 to 45.0; Mo: 2.0 or less; Nb: 0.1 to 0.4; W: 8.0 or less; Ti: 0.6 or less; Al: 0.6 or less; B: 0.01 or less; N: 0.25 or less; the remainder being iron and unavoidable impurities.

Also, an austenitic steel is already described in Japanese laid-open document JP 621 99 753 A, which has the following chemical composition, each in wt. %: C: <0.03; Si: <0.6; Mn: <5.0; P: <0.04; S:<0.03; Cr: 23.0 to 30.0; Ni: 5.0 to 18.0; N: 0.25 to 0.45 or further having one or more of the following elements: Mo: 0.1 to 3.0; Nb: 0.05 to 2.0; Ti: 0.02 to 0.5; Cu: 0.2 to 5; B: <0.01; Ce: <0.05 and Ca: <0.1. This steel also satisfies the formula: Ni+0.5×Mn+30×(C+N)>=20. This steel is used for tubes in a heating apparatus for recovering soda in paper production and has improved load capacity and resistance to grain boundary corrosion.

### SUMMARY OF THE INVENTION

The present invention provides an austenitic steel alloy with excellent corrosion resistance at high temperature stresses from above 600° C. up to 800° C., for use in solar power plants, in particular in molten salt-based solar power plants. Furthermore, a tubular body consisting of this steel alloy, an absorber tube of a solar receiver of a solar power plant consisting of this tubular body as well as a solar receiver having such an absorber tube are to be provided.

According to an aspect of the teaching of the invention, an austenitic steel alloy substantially consisting of, in particular consisting of, the following chemical composition in wt. %: C: 0.01 to 0.10; Si: max. 0.75; Mn: max. 2.00; P: max. 0.03; S: max. 0.03; Cr: 23 to 27; Ni: 17 to 23; Nb: 0.20 to 0.6; N: 0.15 to 0.35; the remainder being iron with melt-induced impurities, at operating temperatures of at least 600° C. to 800° C., having high corrosion resistance and mechanical stability against thermomechanical fatigue and significantly improved economic efficiency in solar power plants, in particular in molten salt-based solar power plants.

The austenitic steel alloy in accordance with the invention has about the same or even improved corrosion properties compared to conventional steel alloys and sufficient creep rupture behavior compared to known alloys at high operating temperatures of at least 600° C. to 800° C.

The inventive combination of the alloy elements chromium—23 to 27 wt. %—and nickel—17 to 23 wt. %—advantageously achieves a corrosion-reducing cover layer formation under the operating conditions.

Advantageously, a cover layer formation can be achieved by appropriate preconditioning, whereby the initial corrosion rate is significantly reduced and the service life is increased. In accordance with the invention, this is achieved by a method for producing a tubular body from the steel alloy in accordance with the invention, in which the tubular body is annealed at annealing temperatures between 800° C. and 900° C. for an annealing time of 0.1 h to 24 h, preferably 2 to 4 h, in an atmosphere containing oxygen and/or nitrogen, in such a way that a cover layer with a thickness of at least 2 μm, advantageously at least 5 μm, and at most 20 μm is produced on the tubular body during the annealing. The corrosion-inhibiting cover layer formed by the inventive alloy composition in service or by appropriate preconditioning is permanent and heals itself in the event of mechanical damage.

The cover layer can be conditioned in the course of preconditioning either before operational use by annealing in a suitable atmosphere, e.g. containing oxygen, nitrogen or other gases, in such a way that layers, e.g. of oxides or nitrides, or combinations thereof, are formed.

However, annealing can also be performed on the primary material for tube production, on the component itself (absorber tube) or directly in the final assembled state of the component.

Advantageous annealing temperatures are between 800° C. and 900° C. with an annealing time at 800° C. of about 3 h. The resulting cover layer has a thickness of at least 2 μm, advantageously at least 5 μm, in order thereby to reduce an initial high corrosion rate. Higher annealing temperatures then correspond to lower annealing times in order to produce a corresponding minimum thickness of the cover layer. However, a maximum annealing temperature of 900° C. should not be exceeded. Also, in the case of preconditioning by annealing, the cover layer should not exceed a thickness of 20 μm in order to prevent the cover layer from chipping off. It is also possible to carry out the preconditioning with the participation of an Al-containing coating and thus further improve the corrosion resistance.

On the other hand, the alloy in accordance with the invention also achieves a high resistance to thermal fatigue, i.e. after a larger number of temperature changes.

The required resistance to creep damage, i.e. a low time-dependent and temperature-dependent plastic deformation under constant load, is achieved by precipitating carbides of the type M23C6 or Nb(C,N). For this purpose, the required minimum content of Nb is determined depending on the present C and N content of the steel during melting according to the following formula (1):

0.3<Nb/(C+N)<3.8 Formula (1)

The following alloy contents for the austenitic steel alloy in wt. % have proven to have an advantageous effect on the corrosion and mechanical properties: C: 0.04 to 0.10, particularly advantageously 0.05 to 0.08; Si: min. 0.1; Mn: min. 0.6; Cr: 23 to 25; Ni: min. 20, particularly advantageously min. 21; N: 0.20 to 0.30.

Respecting the following limit for Nb, C and N according to the following formula (2) has proven to be particularly favorable for the combination of the required properties:

0.4<Nb/(C+N)<2.5 Formula (2)

The required resistance to creep damage is achieved by precipitating carbides of the type M23C6 or Nb(C,N). For this purpose, the alloy elements C and N as well as Nb and Cr are necessary. Compared to other special carbide or nitride formers, such as Ti and V, the addition by alloying of Nb additionally has a grain-refining effect which likewise leads to increased corrosion resistance by virtue of finer grain.

The steel alloy in accordance with the invention can advantageously be used to produce flat steel products, such as e.g. strips or sheets or tubular bodies as seamless or welded tubes. Welded tubes are advantageously produced from correspondingly formed strips or sheets. Seamless tubes can be produced using the typical tube production processes “Mannesmann processes” or e.g. by means of extrusion.

An advantageous application of tubular bodies consisting of the steel alloy in accordance with the invention is as an absorber tube of a solar receiver of a solar power plant for transporting a liquid heating medium, in particular a molten salt.

In one advantageous embodiment of the invention, the absorber tube has a heat-absorbing black coating applied to the outer surface in order to improve the absorber performance. This can be applied subsequently e.g. as a lacquer or can be produced from precursors with the aid of thermal processes. The latter can be e.g. sol-gel layers which, after application to the tube, harden by exposure to sunlight.

Accordingly, an advantageous use of a tubular body, produced from an austenitic steel alloy in accordance with the invention, makes provision to use it as an absorber tube of a solar receiver for transporting a liquid heating medium, in particular a molten salt. Accordingly, a solar receiver advantageously comprises an absorber tube consisting of a tubular body of an austenitic steel alloy in accordance with the invention.

Tests have shown that at required operating temperatures of the absorber tubes of 600° C. and more, the chromium content must be increased to at least 23 wt. % and the nickel content to at least 17 wt. % by reason of the higher corrosion stress.

Alloy elements are generally added to the steel in order to influence specific properties in a targeted manner. An alloy element can thereby influence different properties in different steels. The effect and interaction generally depend considerably upon the quantity, presence of further alloy elements and the solution state in the material. The correlations are varied and complex. The effect of the alloy elements in the alloy in accordance with the invention will be discussed in greater detail hereinafter. The positive effects of the alloy elements used in accordance with the invention will be described hereinafter:

Carbon C: Carbon is required to form carbides, stabilizes the austenite and increases the strength. Higher contents of C impair the welding properties and result in the impairment of the elongation and toughness properties, for which reason a maximum content of less than 0.1 wt. % is set. In order to achieve a fine precipitation of carbides, a minimum addition of 0.01 wt. % is required. For an optimum combination of mechanical properties, in particular in interaction with N, and welding capability, the C content is advantageously set to 0.04 to 1 wt. %, particularly advantageously to 0.05 to 0.08 wt. %.

Nitrogen N: Nitrogen is usually an associated element from steel production. Binding of the nitrogen in the form of nitrides is advantageous by addition by alloying of Nb. Together with chromium carbides, this leads to an additional increase in strength. Therefore, the alloy in accordance with the invention has a minimum content of 0.15 wt. % which in interaction with Nb and C leads to the formation of strength-increasing Nb(C,N). Dissolved nitrogen stabilizes the austenite and at high concentrations leads to embrittlement of the grain boundaries. In the alloy in accordance with the invention, the nitrogen content is therefore limited to a maximum of 0.35 wt. %. N Contents of 0.20 to 0.30 wt. % have proven to be advantageous.

Chromium Cr: Chromium increases strength, reduces the corrosion rate and forms carbides. However, in austenites it can lead to the formation of the embrittling intermetallic sigma phase (Fe, Cr), for which reason an upper limit of 27, advantageously at most 25, wt. % is defined. A minimum content of 23 wt. % is necessary for maintaining the strength and for corrosion protection in the inventive high-temperature use of the alloy in accordance with the invention.

Nickel Ni: Nickel causes the austenite to stabilize at lower temperatures and is therefore necessary for the formation of the austenitic structure. This is all the more the case the more chromium is required e.g. for corrosion protection. The danger of the sigma phase which has am embrittling effect and precipitates as the chromium content increases is reduced by nickel, for which reason nickel contents of 17 to 23 wt. % are necessary in the inventive alloy when chromium contents are between 23 and 27 wt. %. Higher nickel contents lead to an uneconomical concept for the use in accordance with the invention. Against this background, Ni contents of at least 20, advantageously at least 21, wt. % have emerged.

Niobium Nb: Niobium acts as a carbide former in the inventive alloy in such a manner as to increase strength by precipitation of Nb(C,N). The niobium contents must be coordinated with the C and N contents and thus the occurrence of primary precipitations of Nb(C,N), i.e. precipitations already formed during the melting process, must be prevented, for which reason a maximum content of 0.6 wt. % is specified. In order to precipitate the desired contents of secondary Nb(C,N), a content of at least 0.2 wt. % is specified in the alloy in accordance with the invention.

Manganese Mn: Manganese stabilizes the austenite, and so it can be used as a substitute for a nickel content. For this purpose, a minimum content of 0.6 wt. % is optionally required. However, since Mn reduces corrosion resistance compared to nickel, the content is limited to a maximum of 2 wt. %.

Silicon Si: The addition of silicon generally increases corrosion resistance by accelerating the formation of a Cr₂O₃ layer. For this purpose, a minimum content of 0.1 wt. % is optionally added by alloying. High silicon contents cause an acceleration of the precipitation kinetics of the intermetallic sigma phase and render the welding process more difficult. Therefore, the silicon content is limited to max. 0.75 wt. %.

Phosphorus P: Phosphorous is a trace element or associated element from the iron ore and is dissolved in the iron lattice as a substitution atom. Attempts are generally made to lower the phosphorus content as much as possible because inter alia it exhibits a strong tendency towards segregation owing to its low diffusion rate and greatly reduces the level of toughness. The attachment of phosphorus to the grain boundaries can cause cracks along the grain boundaries during hot rolling. For the aforementioned reasons, the phosphorus content is limited to values of less than 0.03 wt. %.

Sulphur S: Sulphur, like phosphorus, is bound as a trace element or associated element in the iron ore or is incorporated by coke during production via the blast furnace route. It is generally not desirable in steel because it exhibits a tendency towards extensive segregation and has a greatly embrittling effect, whereby the elongation and toughness properties are impaired. An attempt is therefore made to achieve amounts of sulphur in the melt which are as low as possible (e.g. by deep desulphurisation). For the aforementioned reasons, the sulphur content is limited to values of less than 0.03 wt. %.

The inventive alloy composition of the new steel alloy enables a very economical application in the field of solar thermal systems at high operating temperatures of 600° C. and above.

### BRIEF DESCRIPTION OF THE DRAWINGS

FIG. 1 is a graph of test results for comparative alloys and an alloy in accordance with the present invention; and

FIG. 2 is a graph of the thermal fatigue behavior of an alloy in accordance with the present invention.

### DETAILED DESCRIPTION OF THE PREFERRED EMBODIMENTS

Table 1 below shows the chemical composition of the tested materials in wt. % (extracts):

| Steel | C | Si | Mn | Al | Cr | Fe | Ni | Mo | Ti | Nb | Co | N |
|---|---|---|---|---|---|---|---|---|---|---|---|---|
| 1 | 0.09 | 0.22 | 0.8 | 0.005 | 18.3 | Bal. | 9.07 | 0.3 | 0.009 | 0.3 | 0.092 | 0.05 |
| (Comp.) | | | | | | | | | | | | |
| 1 (Inv.) | 0.059 | 0.36 | 1.1 | nd | 25.6 | Bal. | 21.2 | nd | nd | 0.46 | — | 0.2 |
| 2 | 0.06 | <0.3 | <1 | <0.025 | 27.1 | Bal. | 32.3 | nd | nd | 0.8 | — | 0.02 |
| (Comp.) | | | | | | | | | | | | |
| 3 | 0.05 | 0.08 | 0.06 | 1.3 | 22.1 | 1.9 | 53.1 | 8.7 | 0.40 | <0.02 | 11.9 | <0.01 |
| (Comp.) | | | | | | | | | | | | |
| 4 | 0.18 | <0.5 | <0.5 | 2.1 | 24.9 | 9.3 | Bal. | — | 0.13 | — | — | |
| (Comp.) | | | | | | | | | | | | |

Comp.: Comparative alloy
Inv.: Inventive alloy
nd: Not determined
Bal.: Remainder

The technical demands placed on the austenitic steel alloy require a combination of alloy elements which, on the one hand, enables a low corrosion rate by reason of the formation of a cover layer under the operating conditions or by reason of conditioning and, on the other hand, enables the required mechanical properties, i.e. high resistance to thermal fatigue. From an economic point of view, the Ni content should be as low as possible.

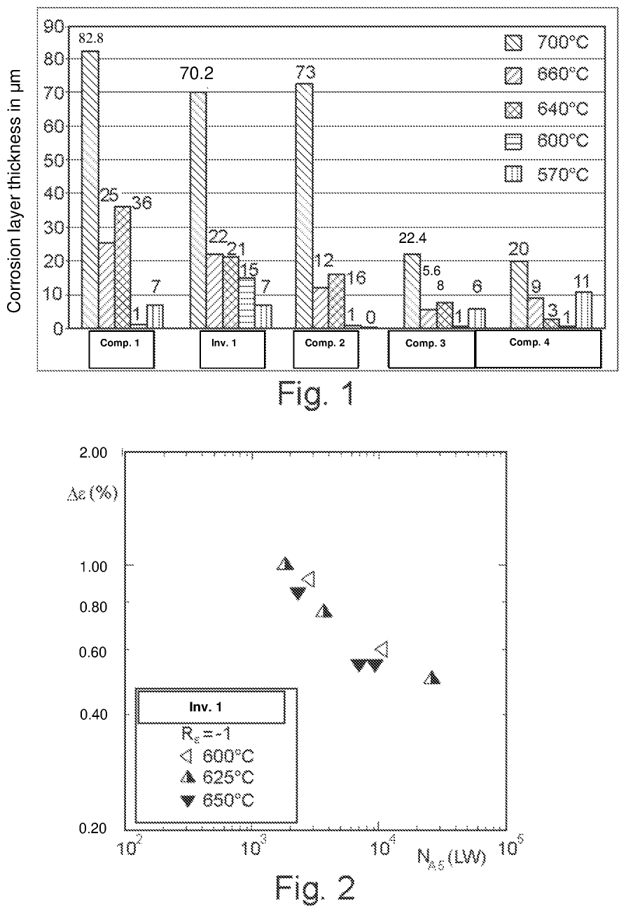

These conditions are fully met with the alloy composition in accordance with the invention. While the comparative steels 2, 3 and 4 have a very high Ni content or an Ni-based alloy, the comparative steel 1 and the inventive steel 1 have significantly lower Ni contents. In relation to the required properties, the inventive steel 1 produces the best results from an economic point of view of a low Ni content. Corresponding sample sheets of the aforementioned alloys have been subjected to a 1000-hour corrosion test in a molten salt of KNO₃-NaNO₃ at temperatures of 700° C., 660° C., 640° C., 600° C. and 570° C. The test results for the tested comparative alloys 1 to 4 and the inventive alloy 1 (designated in FIG. 1 as Comp. 1, Comp. 2, Comp. 3, Comp. 4 and Inv. 1) are illustrated in the form of a bar chart for each alloy in FIG. 1. For each alloy 5 columns are illustrated which, from left to right, are allocated to the temperatures 700° C., 660° C., 640° C., 600° C. and 570° C. of the molten salt. A thickness of a corrosion layer which is formed during the corrosion test is plotted on a y-axis in μm, which is to be interpreted as a measure of the corrosion attack. The corrosion attack for the inventive steel 2 is comparatively moderate and optimum when measured against the lower alloy costs.

The thermal fatigue behavior of a sample consisting of the inventive steel 1 (Inv.1) is shown in a diagram as FIG. 2. A value Δε is plotted on a y-axis as the elongation of the sample between the start and end of the test in percent between 0.2 to 2.0 and on the x-axis a number of load cycles as the number of incipient crack cycles for a load drop criterion of 5% N_{A5} (LW) with values between 10² to 10⁵. R_{ε}=−1 indicates an alternating stress during the fatigue test. The inventive steel 1 (Inv. 1) shows excellent stability under alternating stress, which is almost independent of the temperature. This property is particularly important under operating conditions by reason of the relatively frequent temperature cycles of a solar power plant.

1. An austenitic steel alloy for operating temperatures of at least 600° C. to 800° C. substantially consisting of the following chemical composition in wt. %:
C: 0.01 to 0.10;
Si: max. 0.75;
Mn: max. 2.00;
P: max. 0.03;
S: max. 0.03;
Cr: 23 to 27;
Ni: 17 to 23;
Nb: 0.2 to 0.6; and
N: 0.15 to 0.35;
with the remainder being iron and melt-induced impurities.

2. The steel alloy as claimed in claim 1, having in wt. %:
C: 0.04 to 0.10;
Si: min. 0.1;
Mn: min. 0.6;
Cr: 23 to 25;
Ni: min. 20; and
N: 0.20 to 0.30.

3. The steel alloy as claimed in claim 2, having in wt. %:
0.3<Nb/(C+N)<3.8.

4. The steel alloy as claimed in claim 3, having in wt. %:
0.4<Nb/(C+N)<2.5.

5. A tubular body, said tubular body produced from a steel alloy as claimed in claim 1.

6. The tubular body as claimed in claim 5, wherein the tubular body is a seamless tube.

7. The tubular body as claimed in claim 5, wherein the steel alloy has in wt. % 0.4<Nb/(C+N)<2.5, and wherein the tubular body is a welded tube.

8. An absorber tube of a solar receiver of a solar power plant for transporting a liquid heating medium, wherein said absorber tube is produced from a tubular body as claimed in claim 5.

9. The absorber tube as claimed in claim 8, wherein the absorber tube has an outer surface, and wherein the absorber tube comprises a heat-absorbing coating applied to the outer surface.

10. The absorber tube as claimed in claim 9, wherein the coating is a lacquer application or a sol-gel coating.

11. A solar receiver comprising an absorber tube as claimed in claim 8.

12. A method for producing a tubular body from a steel alloy as claimed in claim 1, said method comprising:
annealing a tubular body at annealing temperatures between 800° C. and 900° C. for an annealing time of 0.1 h to 24 h in an atmosphere containing oxygen and/or nitrogen in such a manner that a cover layer having a thickness of at least 2 μm is produced on the tubular body during the annealing.

13. The method as claimed in claim 12, wherein the annealing time comprises 2 to 4 h.

14. The method as claimed in claim 12, wherein the cover layer produced on the tubular body during the annealing has a thickness of at least at least 5 μm and at most 20 μm.

15. The absorber tube of claim 8, wherein the liquid heating medium comprises a molten salt.

16. The steel alloy as claimed in claim 2, having in wt. %:
C: 0.05 to 0.08; and
Ni: min. 21.

17. The steel alloy as claimed in claim 16, having in wt. %:
0.4<Nb/(C+N)<2.5.

18. The steel alloy as claimed in claim 1, having in wt. %:
0.3<Nb/(C+N)<3.8.

19. The steel alloy as claimed in claim 1, having in wt. %:
0.4<Nb/(C+N)<2.5.

20. The steel alloy as claimed in claim 2, having in wt. %:
0.4<Nb/(C+N)<2.5.
